(19) United States
(12) Patent Application Publication
(10) Pub. No.: US 2022/0291928 A1
(43) Pub. Date: Sep. 15, 2022

(54) EVENT CONTROLLER IN A DEVICE

(71) Applicant: Intel Corporation, Santa Clara, CA (US)

(72) Inventors: Peng CHEN, Beijing (CN); Shuheng MA, Beijing (CN); Shaoqing ZHU, Beijing (CN)

(21) Appl. No.: 17/828,525

(22) Filed: May 31, 2022

(30) Foreign Application Priority Data
May 3, 2022 (CN) PCT/CN2022/090841

(51) Int. Cl. G06F 9/38

(52) U.S. Cl. CPC G06F 9/3861; G06F 9/3867

(57) ABSTRACT

Examples described herein relate to a device comprising circuitry to perform at least one action for at least one error or exception handling event based on a configuration specified by an instruction set consistent with a programmable packet processing language.

### RELATED APPLICATION

This application claims the benefit of priority to Patent Cooperation Treaty (PCT) Application No. PCT/CN2022/090841 filed May 3, 2022. The entire content of that application is incorporated by reference.

### BACKGROUND

A cloud network system can include a Programming Protocol-independent Packet Processors (P4) SmartNIC or infrastructure processing unit (IPU) that can transmit packets at the request of a host or receive packets to be provided to a host. Based on transmission of a packet or receipt of a packet, hardware (e.g., smartNIC or IPU) can send a hardware interrupt to the host and the central processing unit (CPU) responds to the hardware interrupt, and passes the interrupt to a runtime software development kit (SDK), so that the SDK can direct the hardware to a next operation of work. For example, after the hardware completes a packet transmission, software executing on a host reads a result of the operation, or the software to issues a next command.

In cases where packets are incorrectly routed by the hardware, packets can be sent to a wrong path when waiting for a next command from the host. The software may be slow to respond to an indication packets are incorrectly routed by the hardware and correction of packet routing may lead to packets being incorrectly routed, dropped, or re-transmitted. Correction of packet routing can occur by increasing a rate of updating a flow table or speeding up a host's response to interrupts and increasing the processing speed of the hardware.

### BRIEF DESCRIPTION OF THE DRAWINGS

FIG. 1 depicts an example system.

FIG. 2 depicts an example system and operation.

FIG. 3 depicts an example process.

FIG. 4 depicts an example network interface device.

FIG. 5 depicts a system.

FIG. 6 depicts a system.

### DETAILED DESCRIPTION

A host system central processing unit (CPU) can utilize processor cycles to process telemetry data and interrupts. An amount of telemetry data sent from hardware to a host and signaled by interrupt events can be large. If direct memory access (DMA) circuitry is not used to copy telemetry data or other operational data to a host, the CPU is utilized to poll FPGA state and that can impair software application performance. Moreover, the CPU compares the telemetry data against configured values, checks liveliness of flows, and sends messages to a specific host to confirm the speed.

At least to reduce utilization of a host CPU, event and action handling is offloaded from a host to an event controller in a device. The event controller can be configured by a host-executed process to perform corrective actions for specific events or situations such as error or exception handling. In some examples, an event controller is implemented as part of a programmable pipeline in a device can be configured by a program written in a packet processing pipeline language to perform corrective actions for specific events or situations such as error or exception handling. The host or an orchestrator can configure the hardware with a corresponding event and response time to an event may not depend on the host hardware processing speed. Corrective actions or operations can be triggered after the event is reached, which can be completed within a few clock cycles. The event controller need not send hardware interrupts, and may not increase the burden on the host. For example, a command rule cache and local controller in the device can configure the programmable pipeline to respond to an indication of a scenario of incorrectly routed packets, and reduce time to correct such scenario. In some examples, the device can include an event controller circuitry configured with pre-defined event conditions, such as incorrectly routed packets, and responsive operations, such as flow limit or timing trigger. When the event controller circuitry detects a monitored event, the event controller can address the issue based on pre-defined event operations and send a corrective rule based on pre-defined event operations to the corresponding hardware circuitry that reported or performed the event, avoiding the process of sending interrupts to the host and waiting for the next command from the host.

In some examples, a program written in Programming Protocol-independent Packet Processors (P4) can configure event controller circuitry in a device to detect for occurrence of events and perform associated actions. The event controller circuitry can indicate occurrence of an event to a host-executed process when the event is detected or during when an associated action is performed.

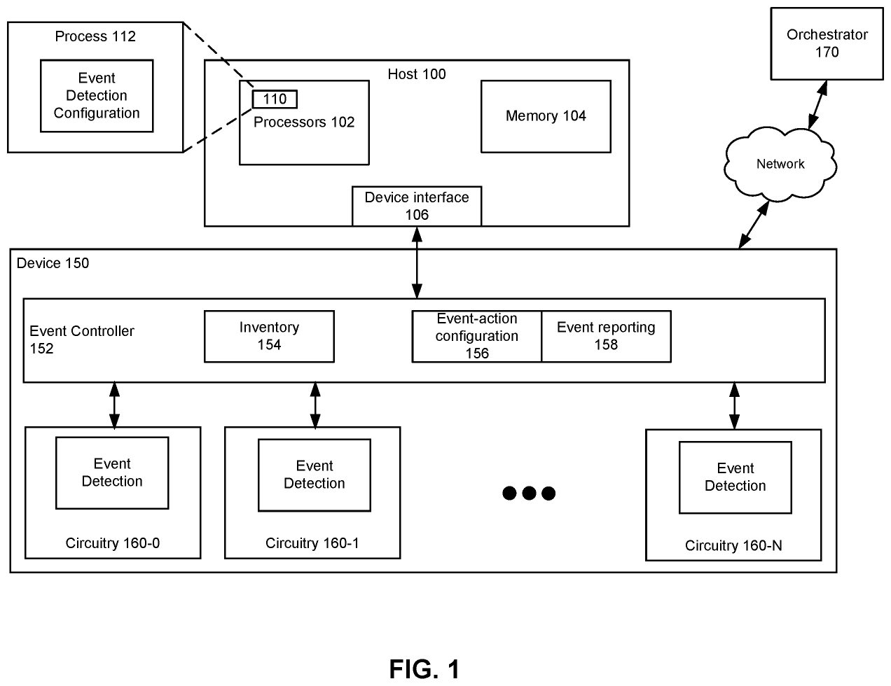

FIG. 1 depicts an example system. Host 100 can offload event detection and actions to event controller circuitry 152 of device 150. Event controller circuitry 152 can store inventory data 154 in a memory. Inventory data 154 can include a file of inventory of hardware devices inside device 150 including circuitry 160-0 to 160-N, wherein N is an integer of 2 or more. Inventory data 154 can indicate a size or number of event-action entries available in event-action configuration table 156, a number of event-action rules supported by event controller 152, types of operations that can be performed by event controller 152, event-action rules that can be performed on network packets by event controller 152 such as longest prefix match (LPM) or identifying values in one or more header fields, memory address of event-action configuration table 156, and counting registers and associated addresses for telemetry data.

One or more of circuitry 160-0 to 160-N can include: network interface (e.g., Ethernet physical layer interface (PHY), Ethernet media access controller (MAC), Ethernet physical medium dependent (PMD) interface), cryptographic circuitry (e.g., encryption or decryption), accelerator (e.g., field programmable gate array), hash calculation, compression, decompression, processor, memory device, and others.

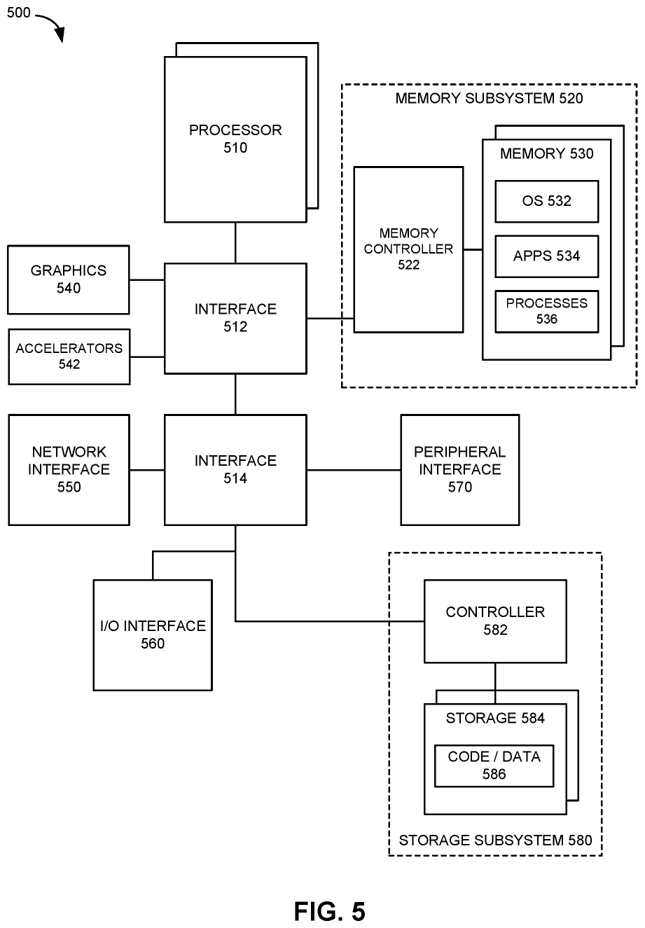

Host 100 can include one or more processors 102, memory 104, and device interface 106, among other components described herein at least with respect to FIGS. 5 and/or 6. Processors 102 can execute one or more processes 110 (e.g., microservices, virtual machines (VMs), containers, or other distributed or virtualized execution environments) that process data. In some examples, process 112 among processes 110 can be based on a software development kit (SDK) that sends control messages to event controller 152. When or after process 112 is initialized, process 112 can read inventory 154 and event-action configuration 156 to generate one or more event-action entries to configure one or more circuitry identified in inventory 154. When a user or host 100 queries for inventory 154 or event-action configuration 156, process 112 can cause display of circuitry inventory to the user or provide a file with inventory 154 and event-action configuration 156. When the user sets an event, such as, for example, restrict traffic of a certain Internet Protocol (IP) address, the user can access event-action configuration 156 via process 112 to determine if that IP address is located on a routing table of device 150.

Host 100 can utilize device interface 106 to communicate with device 150. Interface 106 can provide communications based on Peripheral Component Interconnect Express (PCIe), Compute Express Link (CXL), Universal Chiplet Interconnect Express (UCIe), or other connection technologies. See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof. See, for example, UCIe 1.0 Specification (2022), as well as earlier versions, later versions, and variations thereof.

Process 112 can send placeholder instructions (for a user), which indicate to event controller 152 that an event-action is to be registered in event-action configuration 156 to determine if event controller 152 has sufficient memory resources to add another event-action. If the placeholder instruction is successfully received or not rejected, an indication of success can be provided to process 112 to indicate process 112 is able to configure event controller 152. Otherwise, process 112 can return an indication of failure and process 112 does not attempt to add another event-action to event-action configuration 156. For example, the event controller can reject the placeholder if maximum users exceeded or too many events.

Process 112 may form a request to add another event-action to event-action configuration 156 to event controller 152 and send the request to event controller 152. When receiving a request from host 100, event controller 152 may identify a register or memory address in event-action configuration table 156 in which to store the added event-action and generate a trigger for the event-action in event reporting 158. In some examples, the event-action configurations can be specified by a compiled instruction set consistent with a packet processing pipeline language.

One or more of circuitry 160-0 to 160-N can be configured by event-action configuration 156 to identify an event to detect and report to event controller 152. When the event trigger is received from one or more of circuitry 160-0 to 160-N, the corresponding event may be sent to event controller 152. For example, if the user develops an instruction set to control traffic to or from a certain IP address, process 112 may set an error or exception handling event as an occurrence of one or more of: identification of a particular destination IP address in a packet or traffic statistics (e.g., Internet Protocol (IP) address, packet loss rate, traffic speed, one road trip time, number of packets (e.g., count), number of bytes (e.g., byte count), throughput, channel utilization, and so forth) being outside of a permitted range, and corresponding routing table action as an error or exception handling event of setting an egress port to port X to event controller 152. Based on the event-action configuration, event controller 152 can change an egress port of packets to the destination IP address to a port X. For example, if a telemetry value is outside of a configured range, error or exception handling can be performed.

In some examples, reported events can include telemetry data such as one or more of: utilization of one or more of circuitry 160-0 to 160-N, power consumption of one or more of circuitry 160-0 to 160-N, power state of one or more of circuitry 160-0 to 160-N, memory bandwidth utilization by of one or more of circuitry 160-0 to 160-N, memory allocation to of one or more of circuitry 160-0 to 160-N, frequency of operation of one or more of circuitry 160-0 to 160-N, networking bandwidth used, Collected telemetry, and so forth.

In some examples, telemetry data can be transmitted in metadata of in-band telemetry schemes to orchestrator 170 such as those described in: “In-band Network Telemetry (INT) Dataplane Specification, v2.0,” P4.org Applications Working Group (February 2020); IETF draft-lapukhov-dataplane-probe-01, “Data-plane probe for in-band telemetry collection” (2016); or IETF draft-ietf-ippm-ioam-data-09, “In-situ Operations, Administration, and Maintenance (IOAM)” (Mar. 8, 2020). In-situ Operations, Administration, and Maintenance (IOAM) records operational and telemetry information in the packet while the packet traverses a path between two points in the network. IOAM discusses the data fields and associated data types for in-situ OAM. In-situ OAM data fields can be encapsulated into a variety of protocols such as NSH, Segment Routing, Geneve, IPv6 (via extension header), or IPv4.

Orchestrator 170 can allocate hardware resources to perform workloads based on telemetry and applicable service level agreement (SLA) parameters.

For example, with the Broadband Network Gateway (BNG) 5G (e.g., BroadBand Forum (BBF) TR-092 (2004)) applications can utilize event controller 152 to collect and report statistics.

Event controller 152 can indicate occurrence of an event to host 100 (e.g., process 112, operating system (OS) (not shown), or driver (not shown)) or orchestrator 170 when the event is detected or at least partially overlapping with performance of an associated action. Event controller 152 can indicate the event in a batch with one or more other occurrences of a same event and indicate a time of occurrence of the event and event identifier code. Event controller 152 can indicate occurrence of the event in a batch with one or more different events and indicate a time of occurrence of the events and event identifier codes. Event controller 152 can send a control message to host-executed process 112 to indicate that an event was triggered but may not interrupt processor 102 to indicate such event was triggered.

In some examples, event controller 152 can be implemented as one or more of: field programmable gate array (FPGA), application specific integrated circuit (ASIC), central processing unit (CPU), core, graphics processing unit (GPU), or other circuitry.

Device 150 can include one or more of network interface device, accelerator, storage device, memory device (e.g., memory pool with dual inline memory modules (DIMMs)), graphics processing unit, audio or sound processing device, and so forth. A network interface device can be implemented as one or more of: a network interface controller (NIC), a remote direct memory access (RDMA)-enabled NIC, SmartNIC, router, switch, forwarding element, infrastructure processing unit (IPU), or data processing unit (DPU).

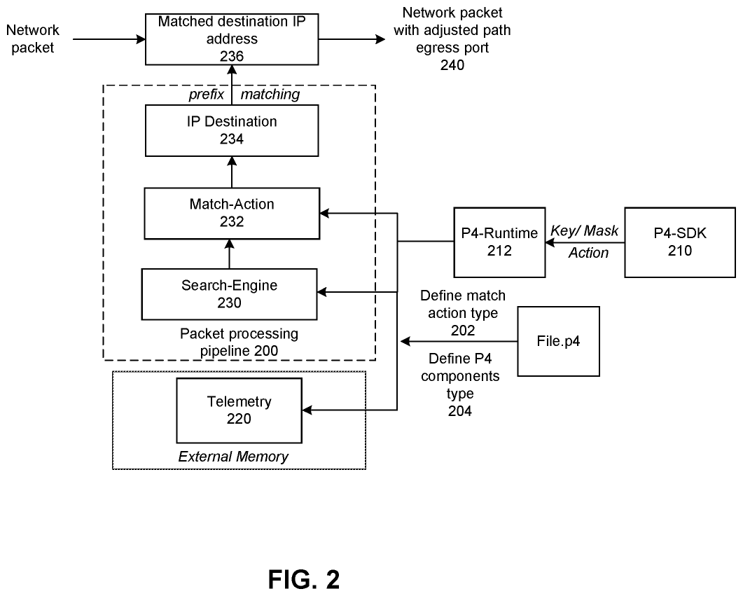

FIG. 2 is a system architecture control flow that configures a packet processing pipeline to perform event correction. Packet processing pipeline 200 can include one or more of the following circuitry: parser, at least one ingress packet processing pipeline, a traffic manager, at least one egress packet processing pipeline, and a de-parser. A network interface device can include packet processing pipeline 200, in some examples.

A flow can be a sequence of packets being transferred between two endpoints, generally representing a single session using a known protocol. Accordingly, a flow can be identified by a set of defined tuples and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow includes a same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier. A packet may be used herein to refer to various formatted collections of bits that may be sent across a network, such as Ethernet frames, IP packets, TCP segments, UDP datagrams, etc. Also, as used in this document, references to L2, L3, L4, and L7 layers (layer 2, layer 3, layer 4, and layer 7) are references respectively to the second data link layer, the third network layer, the fourth transport layer, and the seventh application layer of the OSI (Open System Interconnection) layer model.

Parser can receive a packet as a formatted collection of bits in a particular order, and parse the packet into its constituent header fields. In some examples, the parser can separate packet headers from the payload of the packet, and can send the payload (or the entire packet, including the headers and payload) directly to the deparser without passing through ingress or egress pipeline processing.

In some examples, in response to receiving a packet, the packet is directed to an ingress pipeline among one or more ingress pipelines, where an ingress pipeline may correspond to one or more ingress ports. After processing by the selected ingress pipeline, the packet is sent to the traffic manager, where the packet is enqueued and placed in an output buffer. Traffic manager can dispatch the packet to the appropriate egress pipeline where an egress pipeline may correspond to one or more egress ports.

Traffic manager can include a packet replicator and output buffer. In some examples, the traffic manager may include other components, such as a feedback generator for sending signals regarding output port failures, a series of queues and schedulers for these queues, queue state analysis components, as well as additional components. The packet replicator of some examples may perform replication for broadcast/multicast packets, generating multiple packets to be added to the output buffer (e.g., to be distributed to different egress pipelines).

Ingress and egress pipeline processing can perform processing on packet data. In some examples, ingress and egress pipeline processing can be performed as a sequence of stages, with a stage performing actions in one or more match and action tables. A match table can include a set of match entries against which the packet header fields are matched (e.g., using hash tables), with the match entries referencing action entries. When the packet matches a particular match entry, that particular match entry references a particular action entry which specifies a set of actions to perform on the packet (e.g., sending the packet to a particular port, modifying one or more packet header field values, dropping the packet, mirroring the packet to a mirror buffer, etc.).

Deparser can reconstruct a packet as modified by one or more packet processing pipelines and the payload can be received from the parser. The deparser can construct a packet that can be sent out over the physical network, or to the traffic manager.

A user can develop a P4 file (File.P4) and compile the P4 file to generate a hardware image to configure operation of packet processing pipeline 200 by defining match action table and p4 component list. Type 202 can represent a search engine type (e.g., ternary content-addressable memory (TCAM)), LPM, and so forth) whereas type 204 can represent a table type (e.g., IPv4 table, IPv6 table, and so forth). P4-SDK 210 can provide a key or mask and corresponding action in P4-Runtime 212. The file.p4 can be generated by a developer and P4 runtime can be a compiled file.p4 with application program interface (API) library support to transfer the P4 language and enable operation in an environment. The hardware image and P4-Runtime 212 can define packet processing pipeline operations such as a search engine type 230, corresponding match-action operations 232, and telemetry 220 to monitor. In this example, P4 files can provide an event trigger in a match-action table 232 as an error exception handling to configure packet re-routing in an event a particular destination IP address 234 is present in a packet. For example, at 236, packet processing pipeline 200 can re-route a packet having a destination IP address that matches destination IP address 234 to a different egress port from a switch or other network interface device. Packet processing device 200 can provide modified network packet with adjusted path egress port 240 for egress. Other example triggers for error or exception handling can be based on one or more of: packet loss rate, traffic speed, road trip time (RTT), number of transmitted packets, number of bytes transmitted, throughput, channel utilization, network quality (e.g., congestion), and so forth.

While examples are described with respect to P4, other examples of packet processing pipeline configuration languages can be used such as Broadcom® NPL, Software for Open Networking in the Cloud (SONiC), NVIDIA® CUDA®, NVIDIA® DOCA™, IPDK, among others.

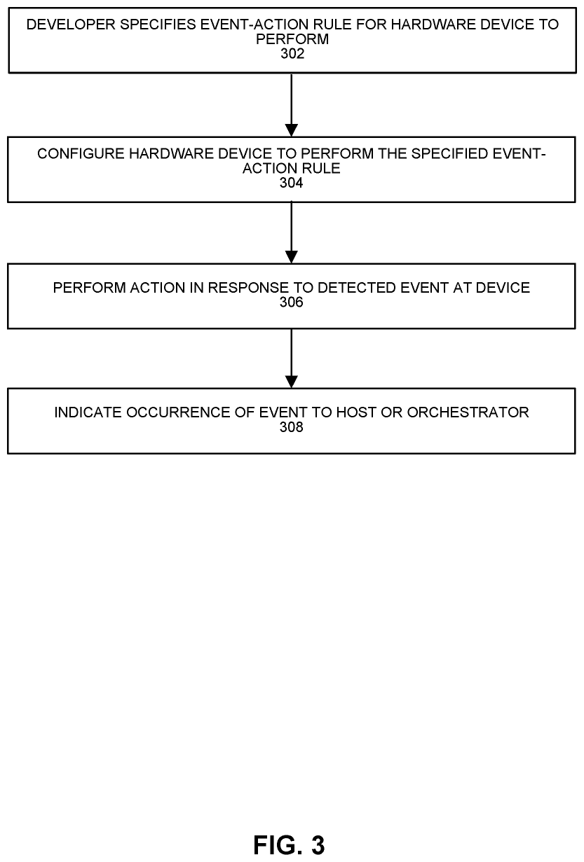

FIG. 3 depicts an example process. At 302, an event-action rule can be specified by a developer. In some examples, the event-action rule can be specified in a configuration consistent with a packet processing pipeline configuration language. In some examples, the event-action rule can configure one or more circuitry or subsystems of a device to report particular events and an event controller circuitry to perform the action associated with an event. At 304, an event-action rule can be provided to the device to configure the hardware to perform an action in response to detection of an event. A host can offload performance of an action in response to detection of an event to the device. At 306, based on detection of an event indicated by a circuitry, the device can perform an action for the event. At 308, the device can report event occurrences to the host or an orchestrator.

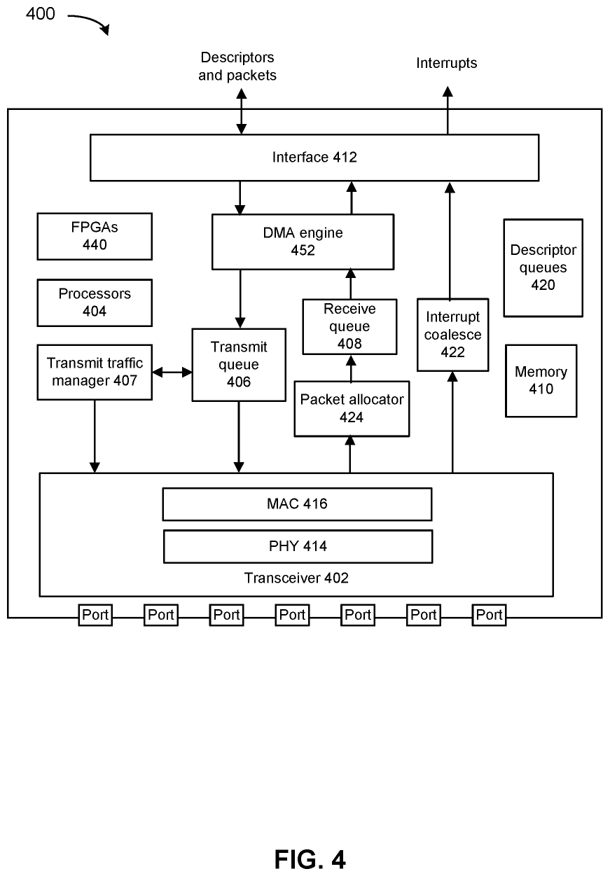

FIG. 4 depicts an example network interface device. In some examples, processors 404 and/or FPGAs 440 can be configured to perform event detection and action. Some examples of network device 400 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 400 can include transceiver 402, processors 404, transmit queue 406, receive queue 408, memory 410, and bus interface 412, and DMA engine 452. Transceiver 402 can be capable of receiving and transmitting packets in conformance with the applicable protocols such as Ethernet as described in IEEE 802.3, although other protocols may be used. Transceiver 402 can receive and transmit packets from and to a network via a network medium (not depicted). Transceiver 402 can include PHY circuitry 414 and media access control (MAC) circuitry 416. PHY circuitry 414 can include encoding and decoding circuitry (not shown) to encode and decode data packets according to applicable physical layer specifications or standards. MAC circuitry 416 can be configured to perform MAC address filtering on received packets, process MAC headers of received packets by verifying data integrity, remove preambles and padding, and provide packet content for processing by higher layers. MAC circuitry 416 can be configured to assemble data to be transmitted into packets, that include destination and source addresses along with network control information and error detection hash values.

Processors 404 can be one or more of: combination of: a processor, core, graphics processing unit (GPU), field programmable gate array (FPGA), application specific integrated circuit (ASIC), or other programmable hardware device that allow programming of network interface 400. For example, a “smart network interface” or SmartNIC can provide packet processing capabilities in the network interface using processors 404.

Processors 404 can include a programmable processing pipeline that is programmable by P4, Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86 compatible executable binaries or other executable binaries. A programmable processing pipeline can include one or more match-action units (MAUs) that can schedule packets for transmission using one or multiple granularity lists, as described herein. Processors, FPGAs, other specialized processors, controllers, devices, and/or circuits can be used utilized for packet processing or packet modification. Ternary content-addressable memory (TCAM) can be used for parallel match-action or look-up operations on packet header content. Processors 404 and/or FPGAs 440 can be configured to perform event detection and action.

Packet allocator 424 can provide distribution of received packets for processing by multiple CPUs or cores using receive side scaling (RSS). When packet allocator 424 uses RSS, packet allocator 424 can calculate a hash or make another determination based on contents of a received packet to determine which CPU or core is to process a packet.

Interrupt coalesce 422 can perform interrupt moderation whereby network interface interrupt coalesce 422 waits for multiple packets to arrive, or for a time-out to expire, before generating an interrupt to host system to process received packet(s). Receive Segment Coalescing (RSC) can be performed by network interface 400 whereby portions of incoming packets are combined into segments of a packet. Network interface 400 provides this coalesced packet to an application.

Direct memory access (DMA) engine 452 can copy a packet header, packet payload, and/or descriptor directly from host memory to the network interface or vice versa, instead of copying the packet to an intermediate buffer at the host and then using another copy operation from the intermediate buffer to the destination buffer.

Memory 410 can be any type of volatile or non-volatile memory device and can store any queue or instructions used to program network interface 400. Transmit traffic manager can schedule transmission of packets from transmit queue 406. Transmit queue 406 can include data or references to data for transmission by network interface. Receive queue 408 can include data or references to data that was received by network interface from a network. Descriptor queues 420 can include descriptors that reference data or packets in transmit queue 406 or receive queue 408. Bus interface 412 can provide an interface with host device (not depicted). For example, bus interface 412 can be compatible with or based at least in part on PCI, PCIe, PCI-x, Serial ATA, and/or USB (although other interconnection standards may be used), or proprietary variations thereof.

FIG. 5 depicts an example computing system. Components of system 500 (e.g., processor 510, memory controller 522, graphics 540, accelerators 542, network interface 550, controller 582, and so forth) can be configured to perform event detection and action, as described herein. System 500 includes processor 510, which provides processing, operation management, and execution of instructions for system 500. Processor 510 can include any type of microprocessor, central processing unit (CPU), graphics processing unit (GPU), processing core, or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a fixed function or programmable offload engine that can be accessed or used by a processor 510. For example, an accelerator among accelerators 542 can provide compression (DC) capability, cryptography services such as public key encryption (PKE), cipher, hash/authentication capabilities, decryption, or other capabilities or services. In some embodiments, in addition or alternatively, an accelerator among accelerators 542 provides field select controller capabilities as described herein. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 542 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

In some examples, OS 532 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, Broadcom®, Nvidia®, IBM®, Texas Instruments®, among others. In some examples, a driver can be configured to negotiate with a device (e.g., one or more of: processor 510, memory controller 522, graphics 540, accelerators 542, network interface 550, or controller 582) to perform event detection and action, as described herein

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory. Network interface 550 (e.g., packet processing device) can execute a virtual switch to provide virtual machine-to-virtual machine communications for virtual machines (or other virtual environments) in a same server or among different servers.

Some examples of network interface 550 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 500. More specifically, power source typically interfaces to one or multiple power supplies in system 500 to provide power to the components of system 500. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Universal Chiplet Interconnect Express (UCIe), Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as Non-volatile memory express (NVMe) over Fabrics (NVMe-oF) or NVMe.

Communications between devices can take place using a network that provides die-to-die communications; chip-to-chip communications; circuit board-to-circuit board communications; and/or package-to-package communications.

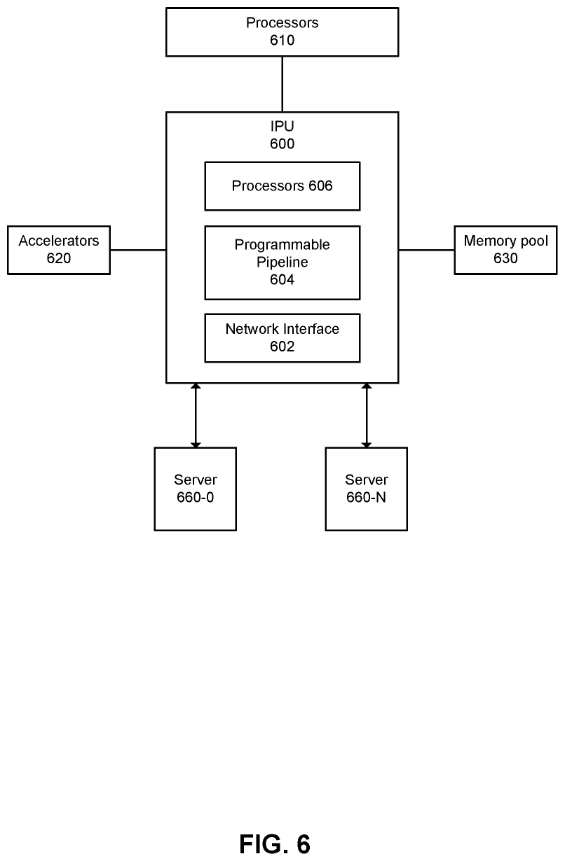

FIG. 6 depicts an example system. In this system, IPU 600 manages performance of one or more processes using one or more of processors 606, processors 610, accelerators 620, memory pool 630, or servers 640-0 to 640-N, where N is an integer of 1 or more. In some examples, processors 606 of IPU 600 can execute one or more processes, applications, VMs, containers, microservices, and so forth that request performance of workloads by one or more of: processors 610, accelerators 620, memory pool 630, and/or servers 640-0 to 640-N. IPU 600 can utilize network interface 602 or one or more device interfaces to communicate with processors 610, accelerators 620, memory pool 630, and/or servers 640-0 to 640-N. IPU 600 can utilize programmable pipeline 604 to process packets that are to be transmitted from network interface 602 or packets received from network interface 602. Programmable pipeline 604 and/or processors 606 can be configured to perform event detection and action, as described herein.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

What is claimed is:

1. An apparatus comprising:
an interface and
a device, communicatively coupled to the interface, wherein the device comprises circuitry to perform at least one action for at least one error or exception handling event based on a configuration specified by an instruction set consistent with a programmable packet processing language.

2. The apparatus of claim 1, wherein
the device comprises a programmable packet processing pipeline and
the programmable packet processing pipeline comprises the circuitry.

3. The apparatus of claim 1, wherein
the programmable packet processing language comprises one or more of: Programming Protocol-independent Packet Processors (P4), Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86.

4. The apparatus of claim 1, wherein
the circuitry comprises one or more of: field programmable gate array (FPGA), application specific integrated circuit (ASIC), central processing unit (CPU), processor, or graphics processing unit (GPU).

5. The apparatus of claim 1, wherein
based on detection of the at least one error or exception handling event, the circuitry is to perform at least one action associated with the at least one error or exception handling event.

6. The apparatus of claim 1, wherein the device comprises one or more of: a network interface controller (NIC), a remote direct memory access (RDMA)-enabled NIC, SmartNIC, router, switch, forwarding element, infrastructure processing unit (IPU), data processing unit (DPU), accelerator, storage device, memory device, graphics processing unit, cryptographic offload circuitry, workload queue manager, or audio or sound processing device.

7. The apparatus of claim 1, wherein
the circuitry is to indicate to a server occurrence of the at least one error or exception handling event after performance of the at least one action.

8. The apparatus of claim 1, comprising a server communicatively coupled to the interface, wherein the server is to offload event detection and action to the circuitry.

9. The apparatus of claim 8, comprising a data center comprising the server and a second server, wherein the circuitry is to provide telemetry data concerning operation of the device to the server and the server is to provide the telemetry data to the second server and where the second server is to execute an orchestrator allocate hardware resources to processes based on the telemetry data.

10. At least one non-transitory computer-readable medium comprising instructions stored thereon, that if executed by one or more processors, cause the one or more processors to:
configure circuitry of a device to perform at least one action for at least one error or exception handling event based on a configuration specified by an instruction set consistent with a programmable packet processing language.

11. The at least one computer-readable medium of claim 10, wherein
the device comprises a programmable packet processing pipeline and
the programmable packet processing pipeline comprises the circuitry.

12. The at least one computer-readable medium of claim 11, wherein
the programmable packet processing language comprises one or more of: Programming Protocol-independent Packet Processors (P4), C, Python, Broadcom Network Programming Language (NPL), NVIDIA® CUDA®, NVIDIA® DOCA™, Infrastructure Programmer Development Kit (IPDK), or x86.

13. The at least one computer-readable medium of claim 10, wherein
the circuitry comprises one or more of: field programmable gate array (FPGA), application specific integrated circuit (ASIC), central processing unit (CPU), processor, or graphics processing unit (GPU).

14. The at least one computer-readable medium of claim 10, wherein based on detection of the at least one error or exception handling event, the circuitry is to perform at least one action associated with the at least one error or exception handling event.

15. The at least one computer-readable medium of claim 10, wherein the device comprises one or more of: a network interface controller (NIC), a remote direct memory access (RDMA)-enabled NIC, SmartNIC, router, switch, forwarding element, infrastructure processing unit (IPU), data processing unit (DPU), accelerator, storage device, memory device, graphics processing unit, cryptographic offload circuitry, workload queue manager, or audio or sound processing device.

16. The at least one computer-readable medium of claim 10, comprising instructions stored thereon, that if executed by one or more processors, cause the one or more processors to:
configure the circuitry is to indicate to a server occurrence of the at least one error or exception handling event after performance of the at least one action.

17. A method comprising:
developing an instruction set consistent with a programmable packet processing language, when executed, to cause circuitry to perform at least one action for at least one error or exception handling event based on a configuration specified by the instruction set.

18. The method of claim 17, wherein the circuitry comprises a programmable packet processing pipeline.

19. The method of claim 18, wherein
the programmable packet processing language comprises one or more of: Programming Protocol-independent Packet Processors (P4), C, Python, Broadcom Network Programming Language (NPL), NVIDIA® CUDA®, NVIDIA® DOCA™, Infrastructure Programmer Development Kit (IPDK), or x86.

20. The method of claim 17, wherein execution of the instruction set causes the circuitry to perform at least one action associated with the at least one error or exception handling event.
